(19) United States
(12) Patent Application Publication
(10) Pub. No.: US 2011/0137866 A1
(43) Pub. Date: Jun. 9, 2011

(54) Method for generating backup script

(75) Inventors: Hun Shin, Daegu (KR); Juncheol Hwang, Anyang-si (KR); Kwang Young Park, Seoul (KR)

(73) Assignee: KOREA I.O. TECH, Seoul (KR)

(21) Appl. No.: 12/659,388

(22) Filed: Mar. 8, 2010

(30) Foreign Application Priority Data
Dec. 3, 2009 (KR) 10-2009-0119022

(51) Int. Cl. G06F 17/00; G06F 12/16

(52) U.S. Cl. 707/648; 707/644; 707/E17.044; 711/E12.103

(57) ABSTRACT

A method for generating a backup script is disclosed. In accordance with the present invention, since the backup script is generated using a backup script generating logic, errors in the backup script may be reduced, and the backup script may be easily modified or complemented even if administrative policies or users are changed.

This application claims the benefit of Korean Patent Application No. 10-2009-0119022 filed on Dec. 3, 2009, which is hereby incorporated for reference.

### BACKGROUND OF THE INVENTION

1. Field of the Invention

The present invention relates to a method for generating a backup script, and more particularly to a method for generating a backup script wherein a backup script generating is employed to generate the backup script to reduce errors in the backup script and facilitate the generation of consistent backup script.

2. Description of the Related Art

A storage system includes a client and a storage server wherein a backup of a data stored in the client is made in the storage server. The storage system makes the backup of the data in the storage server so that the data may be restored when the data is deleted or lost by a mistake of a user, an error of a software, a failure of a hardware, a computer virus, a theft, a cyber attack, a disaster and the like.

The storage system employs an application so-called a storage manager to carry out a backup task. Tivoli Storage Manager (TSM) by IBM and Netbackup by Symantec are some of well-known storage managers.

The storage manager is executed in the storage server. The storage manager provides storage services described below to the client connected to the storage server in order to backup the data and manage archives.

First, the storage manager guarantees a data integrity. The storage manager may protect the data stored in the storage server in order to prevent manipulation.

Second, the storage manager provides a data storage for the data. That is, the storage manager may store the data and programs of the client in storage of the storage server such as a tape cartridge, an optical disk, an opto-magnetic disk and hard disk arrays.

Third, the storage manager provides a security for the data. That is, the storage manager may restore the data and the programs from the storage server when the data is lost.

A conventional storage system employing the TSM by IBM is described hereinafter.

FIG. 1 is a block diagram illustrating the conventional storage system.

Referring to FIG. 1, the conventional storage system comprises a storage server 100 and a client 200. The storage server 100 may be a TSM server and the client 200 may be a TSM client.

The storage server 100 stores a data transmitted from the client 200. The storage server 100 stores the data based on a backup script received from the storage server 100.

The storage server 100 stores the data received from the client 200 in storage media such as a disk in a storage hierarchy and a tape volume.

The client 200 transmits the backup script to the storage server 100 and requests the storage server 100 to store the data. The client 200 may transmit the backup script to the storage server 100 directly. Alternately, the client 200 may transmit the backup script to the storage server 100 via a scheduler.

The storage server 100 carries out a backup task based on the backup script. The backup script includes one or more information on the backup script. The one or more information may be stored in a command format.

The one or more information included in the backup script are as follows.

First, an information on types of backup tools may be included.

When a storage service is provided using the TSM, the information may include the types of the backup tools such as DSMC, backint, domdsmc, tdpsqlc, pcbax, Exchange, brbackup, brarchive, db2, sysback, mkdirback and dtobackup.

When a storage service is provided using the TSM, the information may include the types of the backup tools such as dsmc, backint, domdsmc (for domino), tdpsqlc (for mssql), pcbax (for CBMR), tdpexcc (for exchange server), brbackup (for SAP DB), brarchive (for SAP Archive Log), db2, sysback (for AIX OS Backup), mkdirback (for AIX FileSystem Backup) and dtobackup (for SQL-Backtrack).

Second, an information on backup modes may be included.

When a storage service is provided using the TSM, the information may vary according to the types of the backup tool. For instance, when DSMC is used, the backup mode may be an incremental backup mode wherein the backup task is carried out for a modified portion of the data since a last backup task, a selective backup mode wherein the backup task is carried out for selected files or folders, a archive backup mode and an image backup mode.

Third, the information on a backup type may be included.

The backup type may be a domino backup type, a database export backup type, a file backup type, a database online backup type, a database offline backup type, an operating system backup type, a trans backup type, NAS backup type and an archive log backup type.

Fourth, the information on a backup interval may be included.

The backup interval may be a day, a week or a month.

In accordance with the conventional storage system, the backup script is created by a user. That is, the user should create the backup script, which is required for the backup task, including information on an operating system, the types of the backup tools, the backup mode, the backup type, and the backup interval. Therefore, the user is required to have an expert knowledge on the backup script in order to take advantage of the storage server.

Moreover, the user may possibly create the backup script not suitable for the backup task. For instance, the user may use an incorrect command or may make typographical errors. For another example, the user may create the backup script for an Windows operating system using a sysback tool only used in an AIX operating system which is one of UNIX/LINUX operating system. As a result, an error may occur while carrying out the backup task using the backup script containing such errors by the user.

In addition, the backup script may be created based on different logics and rules according to users or systems since criteria may vary according to administrative policies or characteristics of users. Therefore, when the administrative policies or the characteristics of users change, it may be difficult to even understand the backup script.

### SUMMARY OF THE INVENTION

It is an object of the present invention to provide a method generating a backup script wherein a backup script generating is employed to generate the backup script to reduce errors in the backup script and facilitate the generation of consistent backup script.

In order to achieve above-described object of the present invention, there is provided a method for generating a backup script carried out a storage management server, the method comprising steps of: (a) storing a backup script generating logic for generating the backup script for a backup task; (b) receiving a request for generating the backup script; (c) generating the backup script using the backup script generating logic in response to the request; and (d) transmitting the backup script generated in the step (c) to the storage server.

Preferably, the step (a) comprises classifying and storing the backup script generating logic according to at least one of criteria consisting of an operating system, a backup tool, a backup mode, a backup type and a backup interval.

Preferably, the step (b) comprises receiving the request from one of the client and a user console connected to the client.

Preferably, the request comprises at least one of an identification informations of the storage server and the client, and informations on an operating system, types of backup tools, backup modes, a backup type and a backup interval.

Preferably, the step (c) comprises generating the backup script including a configuration for the backup task and a script section.

Preferably, the configuration is generated based on the request, and wherein the script section is generated automatically based on the configuration using the backup script generating logic.

Preferably, the script section comprises a log information part, a backup start message sending part, a pre-script part, a backup part, a post-script part and a backup end message sending part.

Preferably, the step (d) comprises transmitting the backup script to the storage server using at least one of a client and a user console connected to the client. Preferably, the backup script comprises a task information for the backup task wherein the task information is generated to identify a node name of the client, a backup target, a backup tool, a backup mode, a backup type and a backup interval.

The method in accordance with the present invention may further comprise (e) receiving a backup start log and a backup end log from at least one of the storage server and the client corresponding to the backup start message sending part and the backup end message sending part, respectively.

Preferably, the storage server and the client comprise a TSM server and a TSM client in compliance with TSM (Tivoli Storage Manager), respectively.

### BRIEF DESCRIPTION OF THE DRAWINGS

FIG. 1 is a block diagram illustrating the conventional storage system.

FIG. 2 is a block diagram illustrating a storage system in accordance with the present invention.

FIG. 3 is a flow diagram illustrating a method for generating a backup script in accordance with the present invention.

FIG. 4 illustrates an example wherein the backup script generating logic is classified according to the operating system.

FIG. 5 is a diagram illustrating an example of a backup script in accordance with the present invention.

FIG. 6 exemplifies a task information in accordance with the present invention.

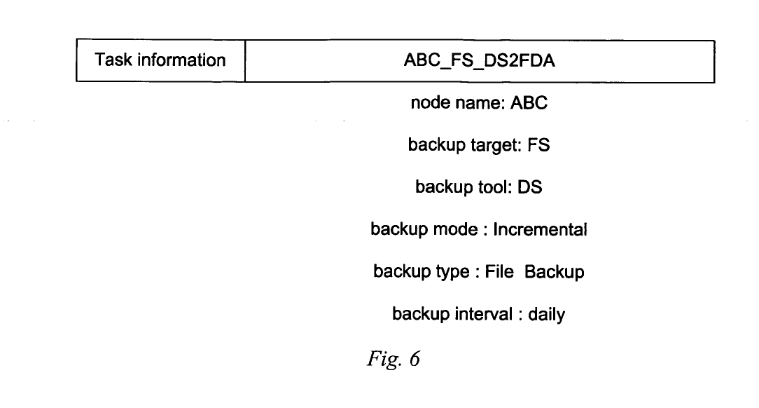

### DETAILED DESCRIPTION OF THE INVENTION

A method for generating a backup script in accordance with the present invention will be described in detail with reference to accompanied drawings.

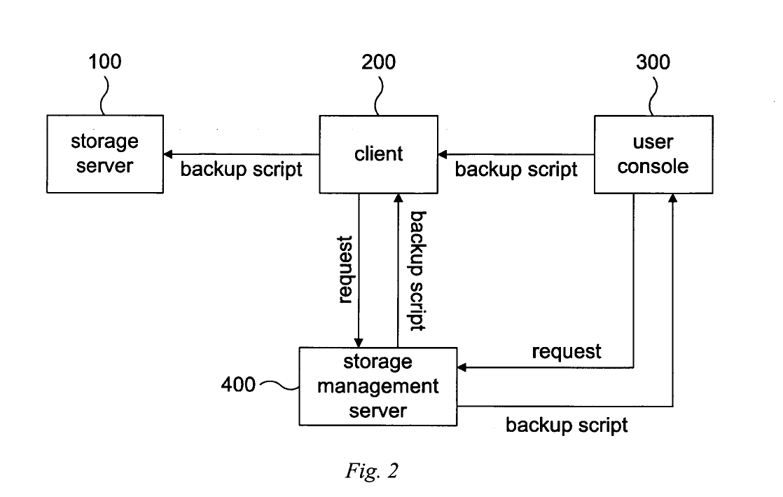

FIG. 2 is a block diagram illustrating a storage system in accordance with the present invention.

Referring to FIG. 2, the storage system in accordance with the present invention comprises a storage server 100, a client 200, a user console 300 and a storage management server 400.

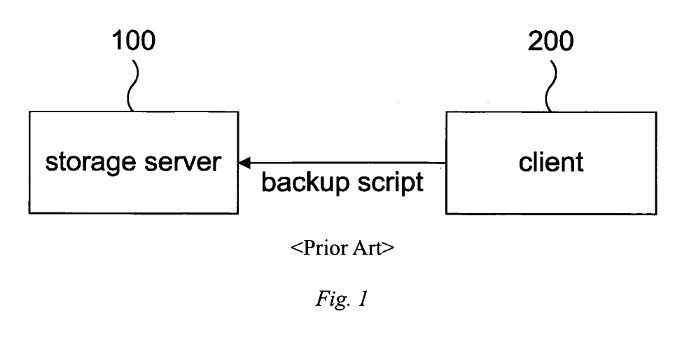

Since configurations of the storage server 100 and the client 200 in accordance with the present invention are identical to those described with reference to FIG. 1, the detailed descriptions thereof are omitted.

The user console 300 is used for requesting a backup script. The user of the client 200 uses the user console 300 to request the backup script for carrying out a backup task. The user console 300 may include, but not limited to a personal computer.

The storage management server 400 is configured to carry out the method for generating the backup script in accordance with the present invention.

The storage management server 400 receives the request for generating the backup script from the client 200 or the user console 300 and generates the backup script. The generated backup script is transmitted to the client 200 or the user console 300.

A method for generating the backup script in accordance with the present invention is described below in more detail.

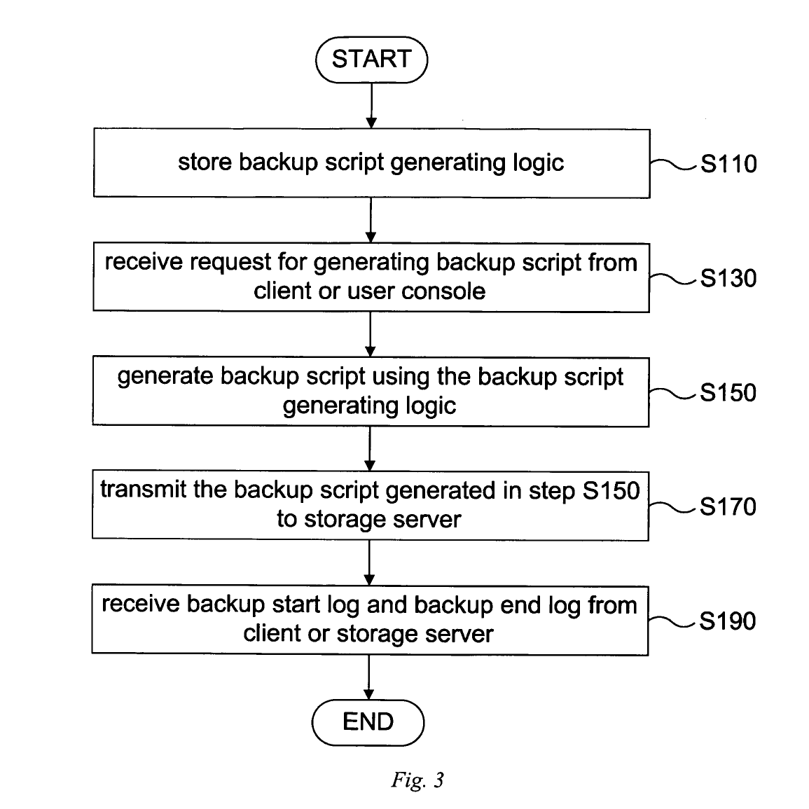

FIG. 3 is a flow diagram illustrating a method for generating a backup script in accordance with the present invention.

Referring to FIG. 3, a storage management server stores a backup script generating logic used for generating the backup script for a backup task (S110).

The backup script generating logic may be classified according to at least one of criteria consisting of an operating system, a backup tool, a backup mode, a backup type and a backup interval, and stored in the storage management server.

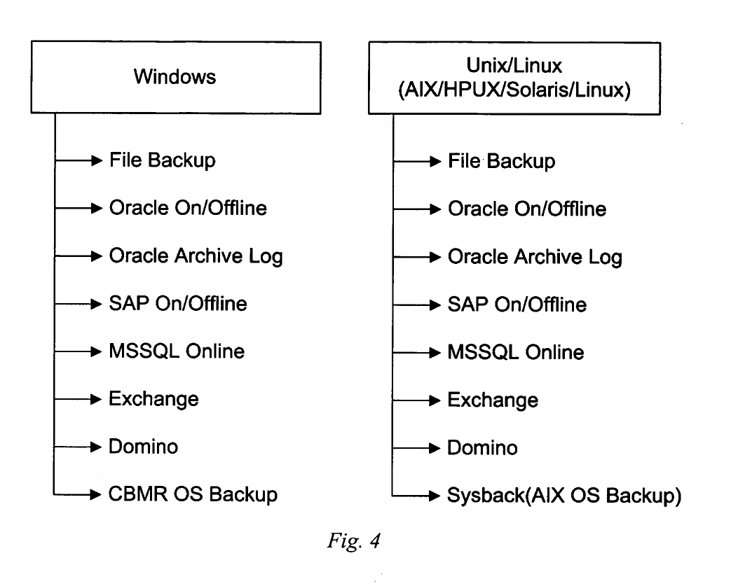

FIG. 4 illustrates an example wherein the backup script generating logic is classified according to the operating system.

Referring to FIG. 4, the backup script generating logic is classified according to types of the operating system, for instance, Windows operating system and Unix/Linux operating system. The backup script generating logic classified according to the type of the operating system may be again classified according to sub-criteria such as File Backup, Oracle On/Offline.

The backup script generating logic may generate the backup script having a standard format associated with applications such as SAP, Exchange and Lotus Domino and databases such as Oracle, SQL and DB2, as well as the backup script associated with a simply file backup or file restore.

Referring back to FIG. 3, the storage management server receives a request for generating the backup script (S130). Specifically, the user inputs a request message for the backup script to be generated via a GUI (Graphical User Interface) provided by the client or the user console connected to the client. The client or the user console generates the request for the backup script based on the request message and transmits the request to the storage management server.

The request may comprise at least one of identification informations of the storage server and the client, informations on the operating system, types of backup tools, a backup mode, a backup type and a backup interval.

The identification informations of the storage management server and the client are generated automatically. For instance, the identification informations of the storage management server and the client may be those of a TSM server and a TSM client. On the other hand, informations on the operating system, the types of backup tools, the backup mode, the backup type and the backup interval may be designated to according the user input.

Thereafter, the storage management server generates the backup script using the backup script generating logic stored in the step S110 in response to the request (S150).

Specifically, the storage management server may generate the backup script using the backup script generating logic based on the informations included in the request.

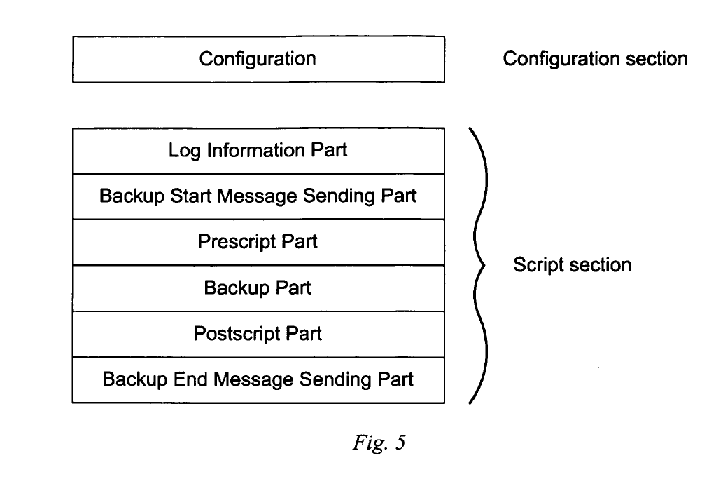

FIG. 5 exemplifies a configuration of the backup script in accordance with the present invention.

Referring to FIG. 5, the backup script comprises a configuration section and a script section.

The configuration section comprises a configuration on the backup task and is generated based on the request.

The configuration comprises informations to carry out the backup task. The informations comprises at least one of the identification informations of the storage management server and the client, the informations on the operating system, types of backup tools, backup mode, the backup type and the backup interval may be designated to according to the user input.

The script section is generated automatically by the backup script generating logic. Preferably, the script section comprises a log information part, a backup start message sending part, a pre-script part, a backup part, a post-script part and a backup end message sending part.

The log information part outputs informations included in the configuration in log format.

The backup start message sending part outputs a backup start log when the backup task starts.

The pre-script part carries out a pre-backup task prior to the backup task.

The backup part carries out the backup task.

The post-script part carries out a post-backup task after the backup task is finished.

The backup end message sending part outputs a backup end log when the backup task is finished.

The backup start message sending part and the backup end message sending part transmit the backup start log and the backup end log, respectively to the storage management server or the client, using a communication protocol such as FTP (File Transfer Protocol).

Moreover, the backup script may comprise a task information for identifying a node name of the client, the backup target, the backup tool, the backup mode, the backup type and the backup interval.

When the node name of the client is “ABC”, the backup target is a file system (FS), the backup tool is dsmc (DS), the backup mode is incremental (2), the backup type is file backup (F) and the backup interval is daily (DA), the task information may be denoted as “ABC_FS_DS2FDA”.

When the backup tool is backint instead of dsmc, BI may be in place of DS. Similarly, when the backup tool is domdsmc, tdpsqlc, pcbax, Exchange, brbackup, brarchive, db2, sysback, mkdirback and dtobackup, DD, TS, CB, EX, BB, BA, D2, SB, MB and DT may be in place of DS, respectively.

The backup mode varies according to the backup tool. When the backup tool is dsmc, selective, incremental, archive and backup image backup modes may be denoted as 1, 2, 3 and 4, respectively. When the backup tool is backint, online and offline backup modes may be denoted as 1 and 2, respectively. When the backup tool is tdpsqlc, full, log, difffull, set, group and file backup modes may be denoted as 1, 2, 3, 4, 5 and 6 respectively.

When the backup type is Domino backup instead of file backup, D may be used in place of F. Similarly, when the backup type is database export backup, database online backup, database offline backup, operating system backup, transbackup, NAS backup and archive log backup, E, O, C, S, T, N and A may be used in place of F, respectively.

When the backup interval is week, month and year, WE, MO and YE may be used in place of DA.

Since the node name of the client, the backup target, the backup tool, the backup mode, the backup type and the backup interval can be identified by the task information, the backup task may be easily summarized by checking the backup task.

Again referring to FIG. 3, the storage management server transmits the generated backup script to the storage server (S170). The storage management server transmits the generating backup script to the client or a user console connected to the client. The client and the user console transmit the received backup script to the storage server. The storage server carries out the backup task based on the backup script.

Each of the backup start message sending part and the backup end message sending part included in the script section generate the backup start log and the backup end log on the backup task and transmit to the storage management server or the client.

Thereafter, the storage management server receives the backup start log and the backup end log from the storage server or the client (S190). When the storage server transmits the backup start log and the backup end log to the client, the client may transmit the received backup start log and the received backup end log to the storage management server.

The storage management server may transmit a backup result on the backup task carried out in the storage server through the backup start log and the backup end log. User may confirm the backup result, i.e., whether the backup task is succeed or not or whether en error is generated or not, based on the backup start log and the backup end log.

The method for generating the backup script in accordance with the present invention is generated the backup script using the backup script generating logic. Therefore, errors in the backup script drew up by the user may be reduced.

In addition, the method for generating the backup script in accordance with the present invention may generate the backup script having a unified format using the backup script generating logic although criteria for drawing up the backup script are vary according to administrative policies or characteristics of users. Therefore, the backup script may be easily modified or complemented even if administrative policies or users are changed.

While the present invention has been particularly shown and described with reference to the preferred embodiment thereof, it will be understood by those skilled in the art that various changes in form and details may be effected therein without departing from the spirit and scope of the invention as defined by the appended claims.

What is claimed is:

1. A method for generating a backup script carried out a storage management server, the method comprising steps of:
(a) storing a backup script generating logic for generating the backup script for a backup task;
(b) receiving a request for generating the backup script;
(c) generating the backup script using the backup script generating logic in response to the request; and
(d) transmitting the backup script generated in the step (c) to the storage server.

2. The method in accordance with claim 1, wherein the step (a) comprises classifying and storing the backup script generating logic according to at least one of criteria consisting of an operating system, a backup tool, a backup mode, a backup type and a backup interval.

3. The method in accordance with claim 1, wherein the step (b) comprises receiving the request from one of the client and a user console connected to the client.

4. The method in accordance with claim 3, wherein the request comprises at least one of an identification informations of the storage server and the client, and informations on an operating system, a backup tool, a backup mode, a backup type and a backup interval.

5. The method in accordance with claim 1, wherein the step (c) comprises generating the backup script including a configuration for the backup task and a script section.

6. The method in accordance with claim 5, wherein the configuration is generated based on the request, and wherein the script section is generated automatically based on the configuration using the backup script generating logic.

7. The method in accordance with claim 5, wherein the script section comprises a log information part, a backup start message sending part, a pre-script part, a backup part, a post-script part and a backup end message sending part.

8. The method in accordance with claim 1, wherein the step (d) comprises transmitting the backup script to the storage server using at least one of a client and a user console connected to the client.

9. The method in accordance with claim 1, wherein the backup script comprises a task information for the backup task wherein the task information is generated to identify a node name of the client, a backup target, a backup tool, a backup mode, a backup type and a backup interval.

10. The method in accordance with claim 7, further comprising (e) receiving a backup start log and a backup end log from at least one of the storage server and the client corresponding to the backup start message sending part and the backup end message sending part, respectively.

11. The method in accordance with claim 1, wherein the storage server and the client comprise a TSM server and a TSM client in compliance with TSM (Tivoli Storage Manager), respectively.
